(19) United States
(12) Patent Application Publication
(10) Pub. No.: US 2025/0079603 A1
(43) Pub. Date: Mar. 6, 2025

(54) POWER STORAGE MODULE

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/661,913

(22) Filed: May 13, 2024

(30) Foreign Application Priority Data
Aug. 29, 2023 (JP) 2023-139160

(51) Int. Cl. H01M 50/242; H01M 10/613; H01M 10/653; H01M 10/6551; H01M 10/6568; H01M 50/213; H01M 50/383

(52) U.S. Cl. CPC H01M 50/242; H01M 10/613; H01M 10/653; H01M 10/6551; H01M 10/6568; H01M 50/213; H01M 50/383

(57) ABSTRACT

The power storage module includes a plurality of electricity storage cells (cylindrical power storage cells), a column portion arranged so as to be surrounded by the plurality of electricity storage cells, and a case accommodating the plurality of electricity storage cells. The column portion extends along the Z direction. The length of the column portion in the Z direction (axial direction) is larger than the length of each of the plurality of power storage cells in the Z direction.

### CROSS-REFERENCE TO RELATED APPLICATION

This application claims priority to Japanese Patent Application No. 2023-139160 filed on Aug. 29, 2023, incorporated herein by reference in its entirety.

### BACKGROUND

### 1. Technical Field

The present disclosure relates to a power storage module.

### 2. Description of Related Art

Japanese Patent No. 4921629 discloses a battery pack structure in which a plurality of cylindrical battery modules are arranged. Each of the battery modules is fixed at both ends in the axial direction by a battery holder.

### SUMMARY

In Japanese Patent No. 4921629, both ends of each of the battery modules in the axial direction are fixed by the battery holder, and therefore an impact applied to the battery holder is directly transmitted to the battery module. It is desired to mitigate an impact on the battery modules (cylindrical power storage cells).

The present disclosure has been made in order to address the above issue, and an object thereof is to provide a power storage module capable of mitigating an impact on cylindrical power storage cells.

One aspect of the present disclosure provides a power storage module including: a plurality of cylindrical power storage cells disposed such that axial directions of the cylindrical power storage cells are substantially parallel to each other; at least one column portion disposed so as to be surrounded by the cylindrical power storage cells; and
a case that houses the cylindrical power storage cells.

The column portion extends along the axial direction.

A length of the column portion in the axial direction is greater than a length of each of the cylindrical power storage cells in the axial direction.

In the power storage module according to the one aspect of the present disclosure, as described above, the length of the column portion in the axial direction is greater than the length of each of the cylindrical power storage cells in the axial direction. Accordingly, at least one of the end portions of the cylindrical power storage cells in the axial direction can be spaced from the case. As a result, it is possible to suppress an impact applied to the case being transmitted to the cylindrical power storage cells as compared with a case where the cylindrical power storage cells are fixed at both ends in the axial direction by the case. Accordingly, an impact on the cylindrical power storage cells can be mitigated.

In the power storage module according to the one aspect, preferably, the column portion is formed with an internal flow path which extends in the axial direction and through which a refrigerant flows, or a cavity portion filled with a fire extinguishing agent. Since an internal flow path is formed in the column portion, the cylindrical power storage cells can be cooled by the refrigerant flowing through the internal flow path. Meanwhile, since a cavity portion is formed in the column portion, the fire extinguishing agent can be discharged from the cavity portion of a ruptured column portion when an impact enough to deform the cylindrical power storage cells is applied to the power storage module.

The power storage module according to the one aspect preferably further includes a cooler housed in the case to cool the cylindrical power storage cells. The cooler may be configured to cool the column portion from one end of the column portion in the axial direction by being in contact with the one end.

According to this configuration, the cylindrical power storage cells can be cooled by the cooler via the column portion.

The power storage module according to the one aspect preferably further includes a heat conductive member disposed between one end of the column portion in the axial direction and the case.

A thermal conductivity of the heat conductive member may be higher than a thermal conductivity of each of the column portion and the case.

According to this configuration, heat exchange between the column portion and the case can be efficiently performed by the heat conductive member. As a result, the column portion can be cooled quickly.

In the power storage module according to the one aspect, preferably, the case includes a wall portion provided on one end side of the column portion in the axial direction, and
a plurality of fins disposed on the wall portion.

A region in which the fins are formed may be provided at a position overlapping the column portion in the axial direction.

According to this configuration, the column portion can be cooled easily by air cooling using the fins.

According to the present disclosure, it is possible to mitigate an impact on a plurality of cylindrical power storage cells provided in a power storage module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view illustrating a configuration of a power storage module according to a first embodiment;

FIG. 2 is a cross-sectional view taken along II-II line of FIG. 1;

FIG. 3 is a cross-sectional view illustrating a configuration of a power storage module according to a second embodiment;

FIG. 4 is a cross-sectional view illustrating a configuration of a power storage module according to a third embodiment;

FIG. 5 is a plan view illustrating a configuration of a power storage module according to a fourth embodiment;

FIG. 6 is a cross-sectional view taken along VI-VI line of FIG. 5;

FIG. 7 is a view showing a relation of thermal conductivity between a heat conductive member and a case and a column portion according to a fourth embodiment; and

FIG. 8 is a cross-sectional view illustrating a configuration of a power storage module according to a fifth embodiment.

### DETAILED DESCRIPTION OF EMBODIMENTS

Hereinafter, an embodiment of the present disclosure will be described in detail with reference to the drawings. In the drawings, the same or corresponding parts are denoted by the same reference numerals, and the description thereof will not be repeated.

### First Embodiment

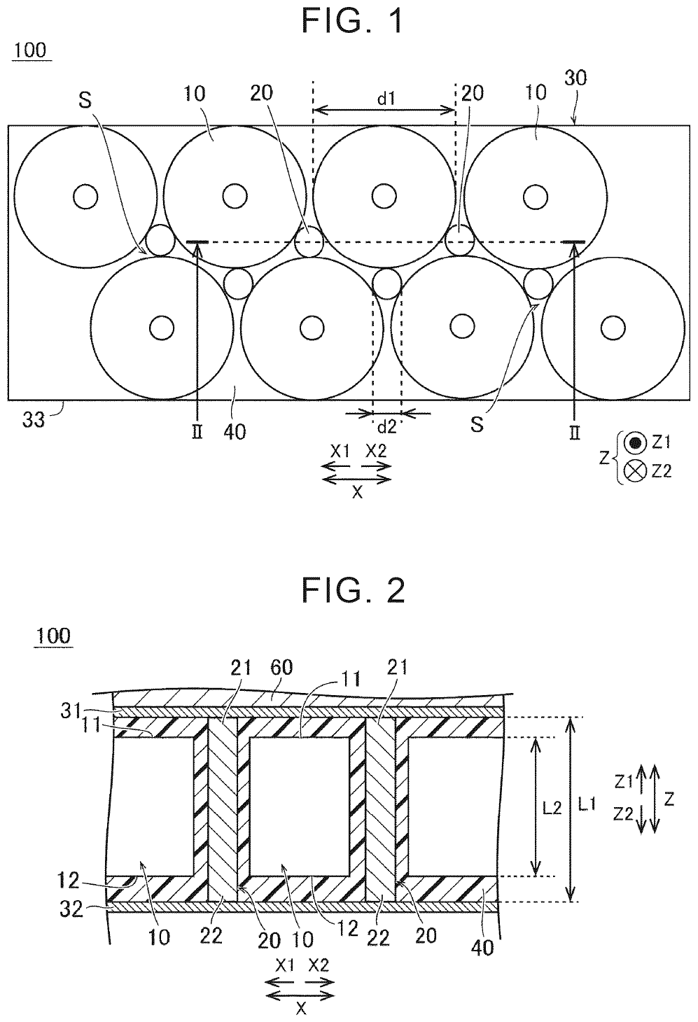

FIG. 1 is a plan view showing an overall configuration of a power storage module 100 according to a first embodiment of the present disclosure. The power storage module 100 includes a plurality of (eight in FIG. 1) power storage cells 10, a plurality of (five in FIG. 1) column portions 20, a case 30, and a heat conductive material 40. The number of the power storage cells 10 and the column portions 20 is not limited to the above example. The power storage module 100 is mounted on, for example, an electrified vehicle. Note that the use of the power storage module 100 is not limited to the vehicle use. Note that FIG. 1 is a plan view of the power storage module 100 in a state in which the upper lid 31 described later is removed. Further, the power storage cell 10 is an example of a “cylindrical power storage cell” of the present disclosure.

Each of the plurality of power storage cells 10 has a cylindrical shape. The plurality of power storage cells 10 are arranged in a grid pattern. The plurality of power storage cells 10 are arranged such that the axial directions are substantially parallel to each other (for example, a deviation of angles between the axial directions is within 1 degree). The axial direction is the Z direction shown in FIG. 1. Further, the Z direction is, for example, a vertical direction, and Z1 direction and Z2 direction are an upper direction and a lower direction, respectively. Note that the Z direction may be other than the vertical direction (for example, the horizontal direction).

Each of the plurality of column portions 20 is disposed so as to be surrounded by the plurality of power storage cells 10. Specifically, each of the plurality of column portions 20 is provided in a gap S formed between three power storage cells 10 arranged adjacent to each other. Each of the plurality of column portions 20 has a cylindrical shape. Each of the plurality of column portions 20 extends along the Z direction. That is, the axial direction of each of the plurality of column portions 20 extends along the Z direction. Each of the plurality of column portions 20 is made of, for example, iron or aluminum.

As viewed along the Z-direction, each of the plurality of power storage cells 10 has a diametric d1 (e.g., 46 mm). When viewed along the Z-direction, each of the plurality of column portions 20 has a diametric d2. The diameter d1 is greater than the diameter d2. For example, the diameter d1 may be four or more times the diameter d2.

The case 30 accommodates each of the plurality of power storage cells 10. The case 30 accommodates each of the plurality of column portions 20. The case 30 is made of, for example, iron or aluminum. Note that each of the plurality of column portions 20 may be formed integrally with the case 30.

The case 30 is filled with a heat conductive material 40 (for example, a thermally conductive resin containing a thermally conductive filler). The thermal conductivity of the heat conductive material 40 is higher than the thermal conductivity of each of the case 30 and the column portion 20. The space other than the space occupied by the power storage cell 10 and the column portion 20 in the internal space of the case 30 is filled with the heat conductive material 40. Accordingly, the efficiency of heat conduction between the power storage cell 10 and the column portion 20 (and the case 30) can be improved (a substantial contact area can be secured).

As shown in FIG. 2, the case 30 includes an upper lid 31, a bottom surface 32, and a side surface 33 (see FIG. 1) connecting the upper lid 31 and the bottom surface 32. The upper lid 31 of the case 30 may be attached to Z2 of the underbody 60 of the vehicle.

Here, in the conventional power storage module, there is a disadvantage that an impact applied to the case is directly transmitted to the battery module. Therefore, the power storage module of the present disclosure has the following configuration in order to mitigate an impact on the power storage cell.

Specifically, in the first embodiment, the length L1 of each of the plurality of column portions 20 in the Z direction is larger than the length L2 of each of the plurality of power storage cells 10 in the Z direction.

Z1 end 21 of each of the plurality of column portions 20 contacts the upper lid 31. Z2 end 22 of each of the plurality of column portions 20 contacts the bottom surface 32. Therefore, each of the plurality of column portions 20 serves as a support of the case 30. Note that the end portion 22 is an example of “one end” of the present disclosure.

Further, as compared with the case where the column portion 20 is not provided, the distance between the support points supporting the case 30 (the contact points between the column portion 20 and the case 30 in the present embodiment) can be easily reduced. As a result, even if the rigidity (mechanical strength) of the case 30 itself is relatively low, a problem is less likely to occur. This makes it possible to reduce the weight of the case 30.

Z1 end portion 11 of each of the plurality of power storage cells 10 is separated from the upper lid 31. Z2 end 12 of each of the plurality of power storage cells 10 is spaced apart from the bottom surface 32. A heat conductive material 40 is filled between the power storage cell 10 and each of the upper lid 31 and the bottom surface 32. Note that the power storage cell 10 may be placed (fixed) on the bottom surface 32, for example.

As described above, in the first embodiment, the length L1 of the column portion 20 in the Z direction is larger than the length L2 of the power storage cell 10 in the Z direction. As a result, the case 30 (the upper lid 31 and the bottom surface 32) is supported by the column portion 20, so that the impact on the power storage cell 10 can be reduced. For example, when a vehicle equipped with the power storage module 100 is traveling on a rough road, an impact transmitted to the power storage cell 10 is suppressed by the column portion 20. In other words, the dimensional difference between the length L1 of the column portion 20 and the length L2 of the power storage cell 10 can be used as a stroke when the road surface interferes with each other.

### Second Embodiment

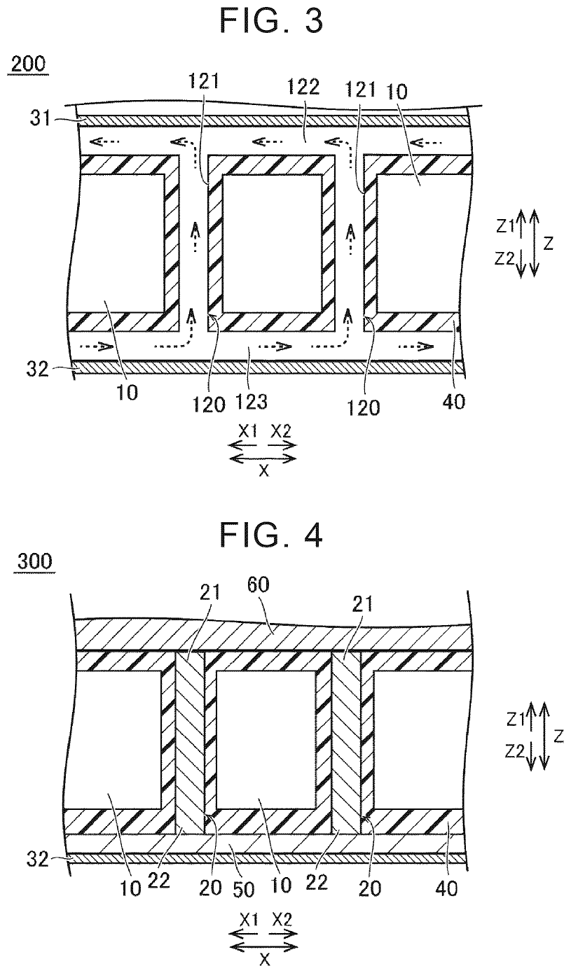

A second embodiment of the present disclosure will be described with reference to FIG. 3. In the second embodiment, an internal flow path 121 is formed in the column portion 120. The same components as those of the first embodiment are denoted by the same reference numerals as those of the first embodiment and will not be described repeatedly.

The power storage module 200 according to the second embodiment includes a plurality of column portions 120 instead of the plurality of column portions 20 of the first embodiment.

Each of the plurality of column portions 120 includes an internal flow path 121 extending in the Z direction. That is, each of the plurality of column portions 120 has a cylindrical shape. In the internal flow path 121, a refrigerant (cooling liquid) flows. In FIG. 3, the flow of the refrigerant is represented by dashed arrows.

Further, the power storage module 200 includes an upper flow path 122 and a lower flow path 123. The upper flow path 122 is provided so as to extend along the upper lid 31, for example, in the X direction. The lower flow path 123 is provided so as to extend along the bottom surface 32, for example, in the X direction. Note that the extending direction of each of the upper flow path 122 and the lower flow path 123 is not limited to the above example. Further, although not shown, each of the upper flow path 122 and the lower flow path 123 may be introduced from the outside to the inside of the case 30 through the side surface 33 (see FIG. 1) of the case 30 (led out from the inside to the outside), for example.

In order to introduce the upper flow path 122 and the lower flow path 123 into the case 30, the power storage module 200 may be disposed inside the vehicle body.

Although FIG. 3 illustrates an example in which the power storage cell 10 and each of the upper flow path 122 and the lower flow path 123 are separated from each other, the present disclosure is not limited thereto. The power storage cell 10 may be in contact with one of the upper flow path 122 and the lower flow path 123.

The internal flow path 121 is electrically connected to each of the upper flow path 122 and the lower flow path 123. Thus, in the example illustrated in FIG. 3, the refrigerant flows through the lower flow path 123, the internal flow path 121, and the upper flow path 122 in this order. The direction in which the refrigerant flows may be reversed as described above.

Note that other configurations and effects are the same as those of the first embodiment, and therefore, repetitive description will not be given.

### Third Embodiment

A third embodiment of the present disclosure will be described with reference to FIG. 4. In the third embodiment, the power storage module 300 is provided with the cooler 50. The same components as those of the first embodiment are denoted by the same reference numerals as those of the first embodiment and will not be described repeatedly.

The power storage module 300 according to the third embodiment includes a cooler 50 for cooling the plurality of power storage cells 10. The cooler 50 is housed in the case 30. The cooler 50 is arranged, for example, along the bottom surface 32. The cooler 50 may include, for example, a cooling fin (not shown) therein, and may be configured to allow air to flow therethrough.

The cooler 50 contacts Z2 end 22 of each of the plurality of column portions 20. Accordingly, the cooler 50 cools each of the plurality of column portions 20 from the end portion 22. The cooler 50 may be contacted with Z1 end portion 21 of each of the plurality of column portions 20. The cooler in contact with the end portion 21 and the cooler in contact with the end portion 22 may be separately provided.

Z1 end 21 of each of the plurality of column portions 20 contacts the underbody 60. That is, the underbody 60 serves as an upper lid of the case.

Note that other configurations and effects are the same as those of the first embodiment, and therefore, repetitive description will not be given.

### Fourth Embodiment

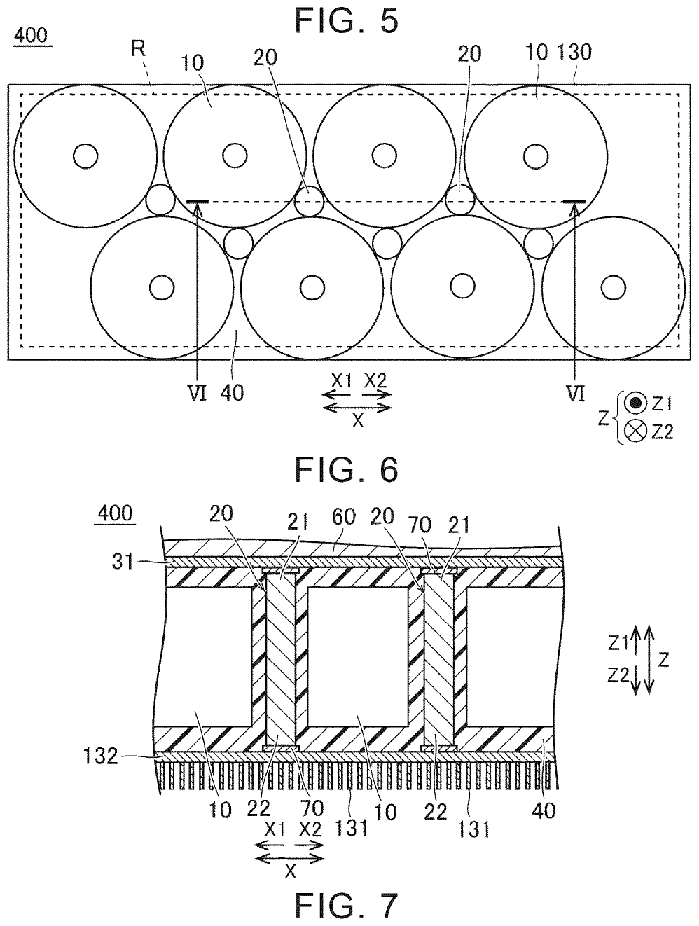

A fourth embodiment of the present disclosure will be described with reference to FIGS. 5 to 7. In the fourth embodiment, a plurality of fins 131 are provided in the case 130 of the power storage module 400. The same components as those of the first embodiment are denoted by the same reference numerals as those of the first embodiment and will not be described repeatedly.

As illustrated in FIG. 5, the power storage module 400 according to the fourth embodiment includes a case 130 instead of the case 30 according to the first embodiment.

The case 130 includes an upper lid 31, a plurality of fins 131, and a bottom surface 132 (both of which are shown in FIG. 6). The bottom surface 132 is provided on the end portion 22 side of each of the plurality of column portions 20. The bottom surface 132 is an example of a “wall portion” of the present disclosure.

In FIG. 5, a region R in which a plurality of fins 131 are formed is represented by a broken line. The region R is provided at a position overlapping each of the plurality of (all) column portions 20 in the Z direction. The region R is formed such that the outer peripheral edge of the region R is along the outer peripheral edge of the case 130. FIG. 5 is a plan view of the power storage module 400 in a state in which the upper lid 31 is removed.

As shown in FIG. 6, each of the plurality of fins 131 is provided so as to protrude Z2 from the bottom surface 132. Each of the plurality of fins 131 may be integrally formed with the bottom surface 132. The X direction in which the plurality of fins 131 are arranged is a direction orthogonal to the traveling direction of the vehicle (the left-right direction of the vehicle).

As a result, an air-cooling structure using outside air can be realized by using the plurality of fins 131, so that the electric power cost at low load can be improved. In addition, the power storage module 400 can be utilized as a natural heat dissipation module in a bicycle or the like.

A heat conductive member 70 is provided between the end portion 21 of each of the plurality of column portions 20 and the upper lid 31. The heat conductive member 70 is sandwiched between the end portion 21 and the upper lid 31. A heat conductive member 70 is provided between the end portion 22 and the bottom surface 132 of each of the plurality of column portions 20. The heat conductive member 70 is sandwiched between the end portion 22 and the bottom surface 132. As a result, each of the plurality of column portions 20 and the case 130 (the upper lid 31 and the bottom surface 132) are thermally connected to each other via the heat conductive member 70.

As shown in FIG. 7, the thermal conductivity of the heat conductive member 70 is higher than the thermal conductivity of each of the column portion 20 and the case 130. The heat conductive member 70 is, for example, a thermally conductive resin sheet containing a thermally conductive filler. In addition, the heat conductive member 70 may be not in the form of a sheet but in the form of a gel (paste). In addition, the heat conductive member 70 may have elasticity and insulation properties.

Note that other configurations and effects are the same as those of the first embodiment, and therefore, repetitive description will not be given.

### Fifth Embodiment

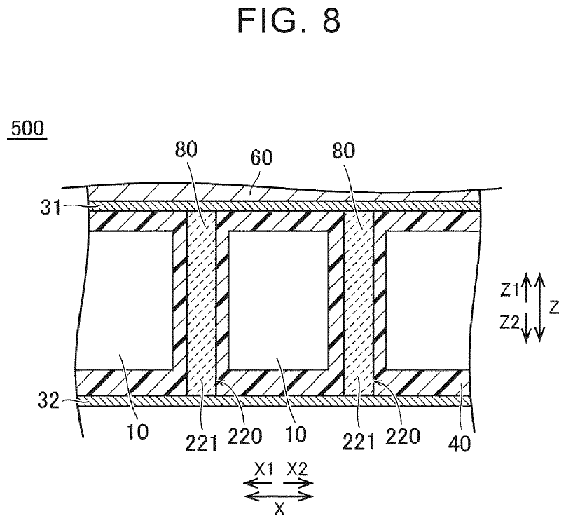

A fifth embodiment of the present disclosure will be described with reference to FIG. 8. In the fifth embodiment, the column portion 220 is filled with a fire extinguishing agent. The same components as those of the first embodiment are denoted by the same reference numerals as those of the first embodiment and will not be described repeatedly.

The power storage module 500 according to the fifth embodiment includes a plurality of column portions 220 instead of the plurality of column portions 20 of the first embodiment.

Each of the plurality of column portions 220 includes a cavity portion 221. The cavity portion 221 is formed so as to extend in the Z direction. That is, each of the plurality of column portions 220 has a cylindrical shape. Each cavity portion 221 of the plurality of column portions 220 is filled with a fire extinguishing agent 80. As the fire extinguishing agent 80, for example, a gas-based fire extinguishing agent such as halon may be used. As the fire extinguishing agent 80, other than a gas-based fire extinguishing agent (for example, a powder-based fire extinguishing agent, a water-based fire extinguishing agent, and the like) may be used.

Note that other configurations and effects are the same as those of the first embodiment, and therefore, repetitive description will not be given.

In the third embodiment, an example in which the underbody 60 serves as an upper lid of the case 30 has been described, but the present disclosure is not limited thereto. Also in the third embodiment, the upper lid 31 may be provided. Also in the first, fourth, and fifth embodiments, the underbody 60 may serve as an upper lid of the case. Also in the second embodiment, the case may be attached to the underbody 60, or the upper lid of the case may be the underbody 60.

In the first to fifth embodiments, the case is filled with the heat conductive material 40, but the present disclosure is not limited thereto. The case may be filled with air without being filled with the heat conductive material 40.

In the first to fifth embodiments described above, an example in which a plurality of column portions are provided has been described, but the present disclosure is not limited to this. Only one column portion may be provided.

In the fourth embodiment, an example in which the heat conductive member 70 is provided has been described, but the present disclosure is not limited to this. The heat conductive member 70 is not provided, and each of the plurality of column portions 20 may be integrally formed with the bottom surface 132 and the plurality of fins 131.

In the fourth embodiment, the fin 131 is provided in the case 130, but the present disclosure is not limited thereto, and the fin 131 may not be provided in the case of the fourth embodiment. In addition, the fins 131 may be provided in the cases of the first, second, third, and fifth embodiments.

Note that the configurations of the above-described embodiment and the above-described modification examples may be combined with each other.

The embodiments disclosed herein are to be considered in all respects as illustrative and not restrictive. It is intended that the scope of the disclosure be defined by the appended claims rather than the description of the embodiments described above, and that all changes within the meaning and range of equivalency of the claims be embraced therein.

What is claimed is:

1. A power storage module comprising:
a plurality of cylindrical power storage cells disposed such that axial directions of the cylindrical power storage cells are substantially parallel to each other;
at least one column portion disposed so as to be surrounded by the cylindrical power storage cells; and
a case that houses the cylindrical power storage cells, wherein:
the column portion extends along the axial direction; and
a length of the column portion in the axial direction is greater than a length of each of the cylindrical power storage cells in the axial direction.

2. The power storage module according to claim 1, wherein the column portion is formed with an internal flow path which extends in the axial direction and through which a refrigerant flows, or a cavity portion filled with a fire extinguishing agent.

3. The power storage module according to claim 1, further comprising a cooler housed in the case to cool the cylindrical power storage cells, wherein the cooler is configured to cool the column portion from one end of the column portion in the axial direction by being in contact with the one end.

4. The power storage module according to claim 1, further comprising a heat conductive member disposed between one end of the column portion in the axial direction and the case, wherein a thermal conductivity of the heat conductive member is higher than a thermal conductivity of each of the column portion and the case.

5. The power storage module according to claim 1, wherein:
the case includes
a wall portion provided on one end side of the column portion in the axial direction, and
a plurality of fins disposed on the wall portion; and
a region in which the fins are formed is provided at a position overlapping the column portion in the axial direction.
